(19) United States
(12) Patent Application Publication
(10) Pub. No.: US 2006/0036970 A1
(43) Pub. Date: Feb. 16, 2006

(54) System for configuring and controlling home appliances

(76) Inventors: Charles Rich, Newton, MA (US); Neal B. Lesh, Cambridge, MA (US); Candace L. Sidner, Newton, MA (US); Andrew Garland, Ridgewood, NJ (US); Shane Leslie Mihelic-Booth, Holland Landing (CA)

Correspondence Address: Patent Department;Mitsubishi Electric Research Laboratories, Inc., 201 Broadway, Cambridge, MA, 02139, US

(21) Appl. No.: 10/919,117

(22) Filed: Aug. 16, 2004

(51) Int. Cl. G06F 17/00

(52) U.S. Cl. 715/821

(57) ABSTRACT

A system includes a single common graphical user interface for a network of home appliances, comprising a communication window and a task window, both of which are connected to the network. A communication window includes agent utterance bubbles associated with a software agent, and user utterance bubbles associated with a user of the appliances. The agent utterance bubbles display agent utterances, and the user utterance bubbles display user utterances to be selected by the user in response to the agent utterances. A task window includes a selection window for selecting tasks and appliances, and an application program interface for a selected task and appliance. A network of home appliances includes several home appliances connected to an appliance controller by a network. The appliance controller includes the single common graphical user interface.

### FIELD OF THE INVENTION

The present invention relates generally to the field of home appliances, and more specifically to configuring and controlling home appliances.

### BACKGROUND OF THE INVENTION

Most people have great difficulty performing advanced operations on digitally-enabled household appliances. This problem is getting worse as more customization and programming operations are added to appliances. The difficulty of performing the operations on many home appliances is further exacerbated by a lack of interface consistency between products, especially for seldom-used operations. Furthermore, this interface incompatibility problem is very difficult to address on small, low-resolution displays, and limited control buttons typically found on home appliances.

The increasing feasibility and popularity of home networking provides an opportunity to address this problem. Many appliances in a house can share a single base station, to which the appliances are connected by a home network. Using home networking to share a larger and more sophisticated interface makes possible a new style of collaborative interface in which the system actively helps the user, especially with complex features that are only occasionally used.

### SUMMARY OF THE INVENTION

A system includes a single common graphical user interface for a network of home appliances, including a communication window and a task window, both of which are connected to the network.

A communication window includes agent utterance bubbles associated with a software agent, and user utterance bubbles associated with a user of the appliances. The agent utterance bubbles display agent utterances, and the user utterance bubbles display user utterances to be selected by the user in response to the agent utterances.

A task window includes a selection window for selecting tasks and appliances, and an application program interface for a selected task and appliance.

A network of home appliances includes several home appliances connected to an appliance controller by a network. The appliance controller includes the single common graphical user interface.

### BRIEF DESCRIPTION OF THE DRAWINGS

FIG. 1 is a block diagram of a network of home appliances according to the invention;

FIG. 2 is a block diagram of an appliance controller according to the invention;

FIG. 3 is a block diagram of a user interface according to the invention; and

FIG. 4 is a diagram of a graphic user interface according to the invention.

### DETAILED DESCRIPTION OF THE PREFERRED EMBODIMENT

System Structure

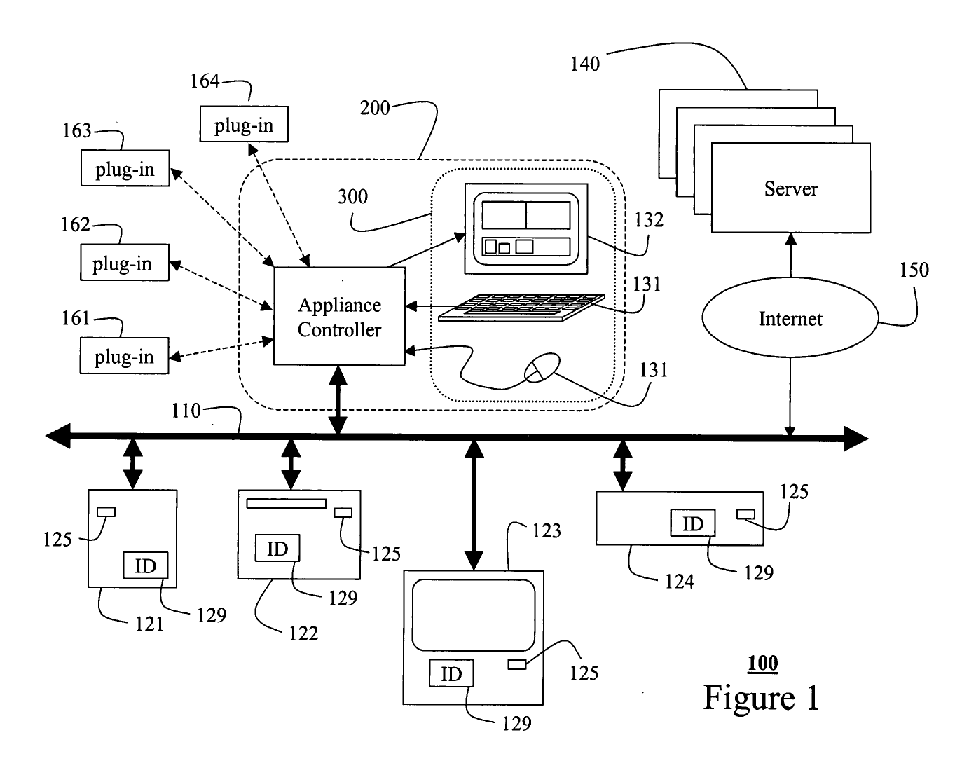

FIG. 1 shows a home appliance system 100 according to the invention. The system 100 includes a network 110 connected to home appliances 121-124, and an appliance controller 200. The appliance controller 200 includes a user interface 300 including an output interface 132 and an input interface 131. The appliances can also include I/O interfaces 125, although this is not required. Each appliance has an associated identity (ID) 129. The appliance controller also includes a scheduler.

The network 110 can be wired or wireless, and use any known type of network protocol. The appliances can include any household consumer device that performs operations for the consumer and has either limited or no user input or output. The appliances may also have limited computational abilities. For each appliance, an appliance-specific plug-in 161-164 is provided by the appliance manufacturer or a third party.

The plug-ins can be delivered to the appliance controller using a CD-ROM, the Internet 150 or by directly programming the appliance controller. In addition, the network 110 has access, via the Internet 150, to servers 140 associated with the appliances. The servers can be operated by the manufacturers of the appliances in a conventional manner.

The appliance controller 200 can be implemented as software on a laptop computer, desktop computer, PDA computer, or dedicated processor. The output interface 132 for the appliance controller 200 can be a display screen or a microphone or both. The input 131 to the appliance controller 200 can include a touch screen, mouse, or keyboard.

System Operation

The appliance controller 200 sends operations to the appliances. Operations are instructions that control the functions of the appliances. In general, operations can be performed on an appliance either through its user interface e.g., buttons and sliders, or over the network 110. The appliance controller sends its operations over the network. For example, operations set a target temperature for a furnace, or turn off all the lights in a house.

In response to operations from the appliance controller, the appliances send state information over the network 110 to the appliance controller. The appliances can also initiate the sending of the state information to the appliance controller over the network 110. For example, a washer/dryer appliance sends state information to the appliance controller when the appliance becomes unbalanced, or when the appliance finishes a current cycle.

For each appliance, there is a set of tasks, which can be achieved by performing operations on that appliance. For example, a common task for a washer/dryer is to clean clothes. Many tasks can be broken down into other tasks, such as washing the clothes and then drying them, each of which can be achieved by performing a series of operations.

The invention enables users to perform complex tasks, such as configuring the appliances for operation and scheduling the configured operations of the appliances using the appliance controller 200, instead of using the interfaces 125 on the appliances.

Typical prior art appliance interfaces are highly specific for the appliance, and even appliances of the same type made by different manufacturers present entirely different interfaces. Therefore, as an advantage, the invention uses a single common user interface for all of the appliances. Furthermore, the appearance and interactions with the user interface is uniform for all the appliances. This means that the user does not have to learn how to use a unique style of interface for complex tasks for each different type of appliance. Instead, the user performs complex tasks identically for each appliance.

In addition, the user interface is collaborative. By being collaborative, we mean that the system and the user perform actions and utterances to perform tasks. Because the user interface is collaborative and easy to use, it is especially advantageous for complex tasks that are performed occasionally.

All operations, simple and complex can be specified using the appliance controller. Then, the operations are downloaded from the appliance controller to the appliance on the network 110. Under this approach, the appliances do not need to include input and output capabilities to support every operation because appliance operations can be specified using the appliance controller, instead of the appliance. In particular, the appliance no longer needs to support user interfaces for infrequent or complex operations, which are easier to specify on the appliance controller. This means that the appliances can be simpler and cheaper to manufacture.

Appliance Controller Structure

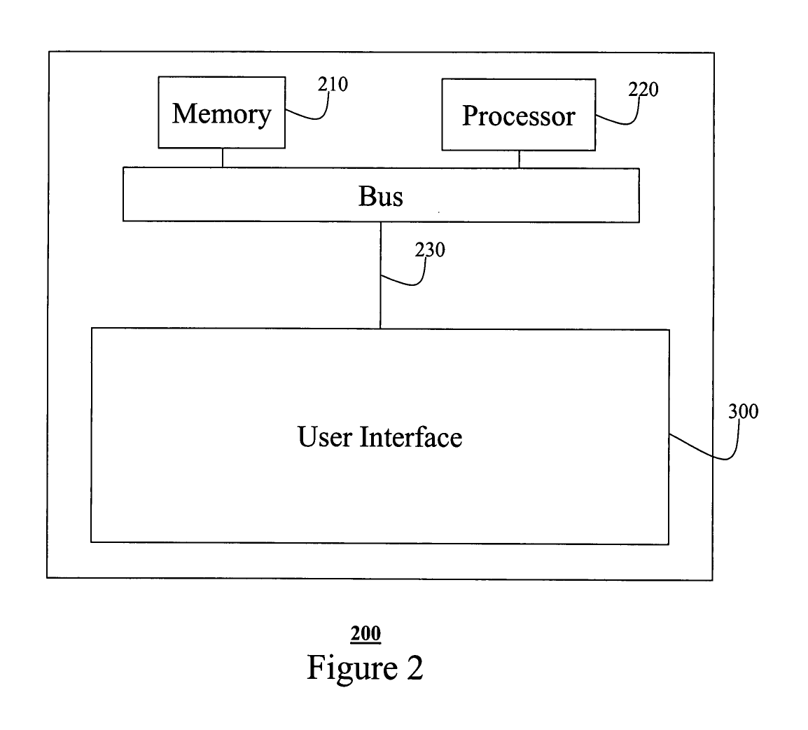

FIG. 2 shows the appliance controller 200 according to the invention. The appliance controller 200 includes a memory 210, a processor 220, and a user interface 300 connected to each other by a bus 230.

Appliance Controller Operation

The memory 210 stores the software that runs the user interface 300 and the system data generated by the appliance controller software. The processor 220 executes instructions in the appliance controller software stored in memory.

Plug-In

For each appliance, there is an appliance specific plug-in 161-164 that is an input to the appliance controller 200. The plug-in is data that are stored in the appliance controller memory 210. The plug-in includes an application program interface (API) for that the appliance that specifies the operations that the appliance can accept over the network 110 and what state information the appliance sends over the network in response to operations. The plug-in also includes a task model, which describes the tasks that the appliance supports. The task model is used by the software agent 310. The plug-in also includes software for producing a graphics user interface (GUI) for the appliance, which is used as part of the output user interface 132, in particular a task window 304.

User Interface Structure

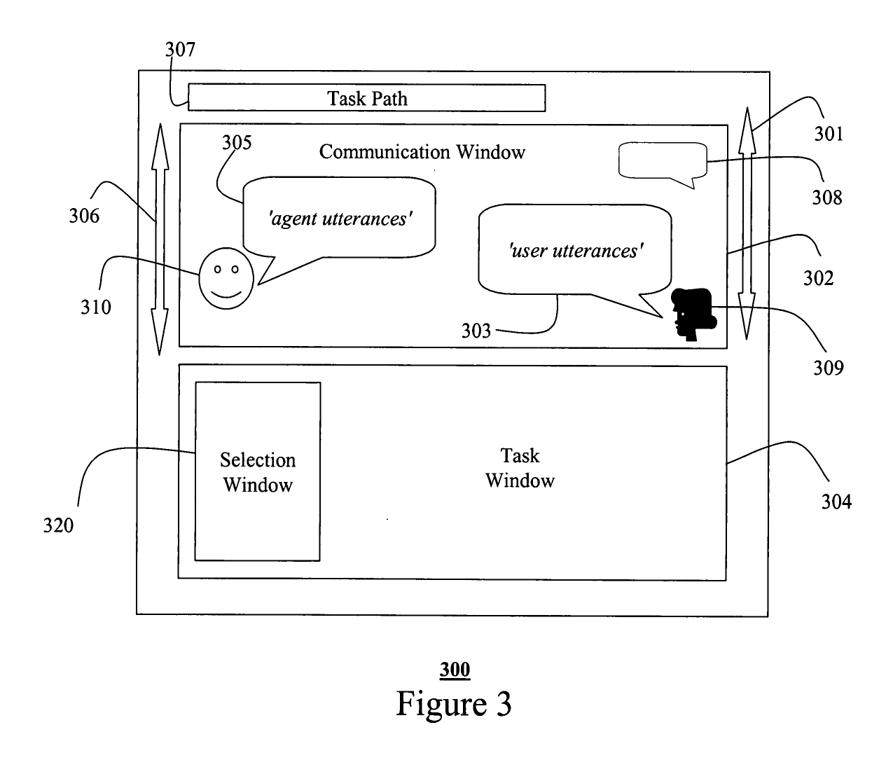

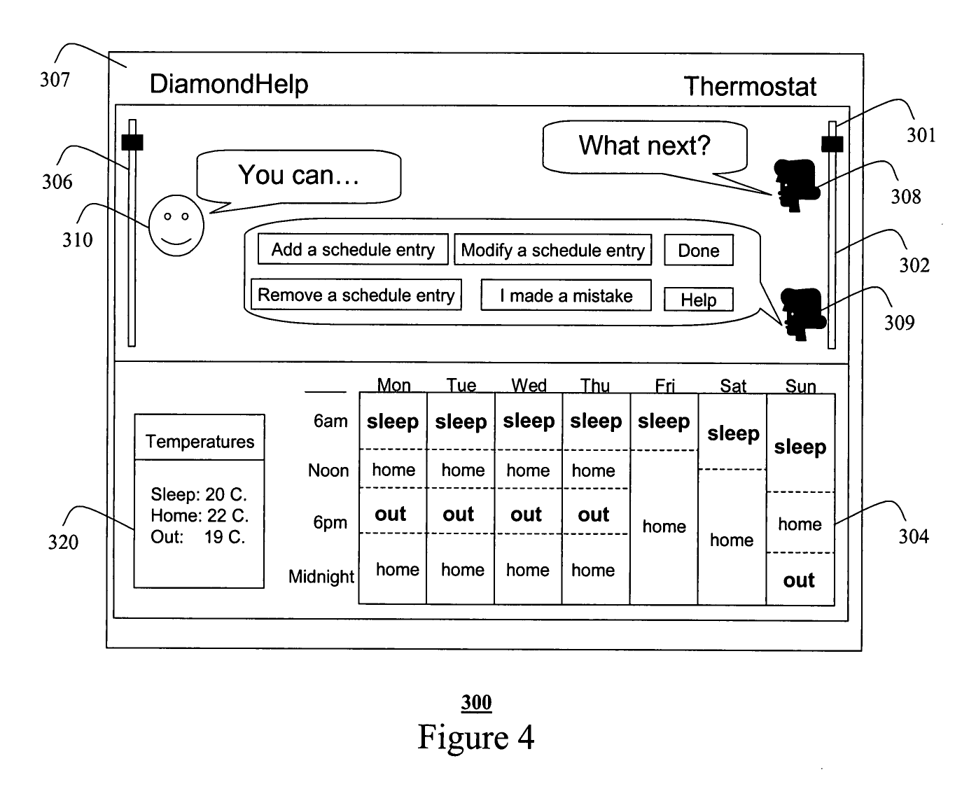

FIGS. 3 and 4 show the user interface 300 according to the invention. FIG. 4 shows a diagram of the user interface 300 using examples for the following elements. The user interface includes a communications window 302 and task window 304. The communications window 302 contains agent utterance bubbles 305 associated with a software agent 310 and user utterance bubbles 303 associated with a user 309. There are scroll bars 301, 306 and a task path 307 associated with the communications window 302.

User Interface Operation

In our preferred embodiment, the appliance controller has a single, common user interface 300 for all appliances.

Utterances are statements in a natural language, such as English or Japanese. The appliance control software generates agent utterances 305 to be acted upon by the user 309. These utterances can be thought of as coming from the agent 310, which helps the users operate and control the appliances. The system also allows the user to select user utterances 303 in response to the agent utterances.

The agent utterances 305 can be displayed or vocalized using a monitor or a speech synthesizer or both. The user utterances can be selected using a keyboard, a mouse, a touch screen, or speech via a speech recognition subsystem. The sequence of agent and user utterances is called a dialog and resembles a discussion between two people. The utterances 303 and 305 are displayed in the communication window 302.

The structure and content of the task window 304 change as the user performs operations and tasks. For example, if the user is using the appliance controller to operate a DVD device, then the task window 304 contains the graphics user interface (GUI) for the DVD device. The GUI in the task window is part of the appliance-specific plug-in associated with that appliance. The task window 304 can also contain a selection interface 320 that allows the user to select tasks and appliances.

An action is an instruction that is issued through the task window 304. The user can perform actions in the task window 304, such as clicking GUI buttons or dragging GUI elements from one place to another. The appliance controller can also perform actions in the task window. In general, the appliance controller can perform every action that the user can. Optionally, an icon, e.g., a ‘pointing hand’ can be displayed to indicate what action the appliance controller is performing. For example, the icon is positioned over a displayed ‘button’ to indicate that the appliance controller is interacting with that button.

The communications window is loosely modeled after the Apple chat window system. The communication window contains a list of all utterances. The agent utterances 305 are left justified and displayed in the bubble 305 that points to an icon representing the agent 310. The user utterances are right justified in the bubble 303 that point to an icon 309 that represents the user.

As the dialog progresses, the utterances ‘scroll-up’ and disappear from the window 302, so that only the most recent utterances are displayed. Previous utterances in one or more bubbles 308 are shown with a lesser intensity (darker) than brighter more recent utterances.

We refer to a state of the task and communications windows as a current “context” of the user interface. At any given point, there is an “active” user bubble that contains a list of possible utterances; the user can select an utterance from the list by clicking on the utterance using a mouse, by direct touching, or by using voice recognition.

The set of utterance options in the active user bubble are generated by the appliance controller from the context and information included in the plug-in for that appliance. The set of options can also be designed manually, i.e., scripted, by the appliance manufacturer.

Some utterances are always present in the list of possible utterances in the active user bubble. In particular, the user always is given the options of selecting “I made a mistake,” “I am done,” and “Help me.” Selecting the “I made a mistake” option indicates to the agent that the user has made an error. If an error is made, then the appliance controller initiates a dialog to identify the error and to help correct the error. If the user selects “I am done,” then the user indicates to the agent the current task has been completed. In some cases, when the user selects “I am done,” the appliance controller initiates a dialog to determine, which task the user has completed when it is not clear from the context. If the user selects “Help me,” then the appliance controller initiates a dialog to determine what additional information the user needs.

When the active user bubble does not contain options for how to proceed with the current task, the appliance controller adds a “What next?” option to the active user bubble. When the user selects the “What next?” option, the appliance controller displays a list of possible tasks that the user can work on next in the active user bubble.

The user can view any part of a history of utterances in the communication window 302 using the scrolling bars 301 and 306.

The user can also direct the appliance controller to a previous state by selecting a previous utterance in the history. At that point, the state of the appliance controller is returned to the state corresponding to the selected utterance.

In our preferred embodiment, the application controller uses A method described in U.S. Pat. No. 5,819,243, “System with collaborative interface agent,” issued to Rich on Oct. 6, 1998, incorporated herein by reference. That method operates the dialog in the communication window 302, the task path 307, performs agent actions in the task window 304, and the downloading of programs to the appliance.

Similar to human collaboration, the users can always choose to either perform an action in the task window or select an utterance using the communication window 302.

The task path 307 encapsulates the set of tasks that have lead to the current task in the interface 300. For example, if the user is scheduling a vacation, and has already selected the first day of the vacation and is now scheduling the last day of the vacation, the task path presents “Schedule a vacation,” followed by “Select the last day,” as the activities displayed in the task path 307. If the user makes a mistake and needs help with selecting the day, the task path displays “Schedule a vacation,” followed by “Select the last day,” followed by “Help.”

Optionally, the communication window includes descriptions of the user actions and appliance controller actions. That is, in addition to the utterances that appear in the communications window, the communications window can contain natural language descriptions of the actions that were performed due to the utterances.

Alternatively, some subset or summary of actions can be described in the communications window. For example, if the user performs many successive actions, these actions can be summarized in a single line indicating how many or what type of appliance operations the user performed. For example, if the user changes the target temperatures for several different zones of the home thermostat by a series of actions in the task window, then the communications window can describe these actions with the single line “User adjusts temperature settings.”

Appliance Structure

As stated above, the appliance can include input and output interfaces, a processor, and memory storing an identity, connected by busses in a conventional manner. The input interfaces can include buttons, dials, or touch screens. The output interfaces can include LED or LCD displays.

Appliance Operations

In our preferred embodiment, a presence of an appliance is indicated to appliance controller 300 when the appliance is connected to the network 110. Alternatively, a user indicates the presence an appliance to the appliance controller, e.g., by providing the identity 129 of the appliance. The appliance controller can acquire the application program interface (API) needed to control a newly connected appliance by, for example, connecting to one of the servers 140, or from information on a compact disk.

The appliance can be made simpler and less expensive when the appliance is designed for our system because the most complex operations are done through the appliance controller rather than on the appliance. Therefore, the appliance requires less input and output functionality and less computational power.

For example, a home thermostat does not need to contain a display and buttons to schedule future temperatures, because that can be done with the appliance controller.

Appliance Controller Functions

The appliance controller can help users with the following functions: program generation, scheduling future operation of appliances, dynamic control of appliances, and creating aggregate consumer feedback for the appliance manufacturer.

Program Generation

One function that the appliance controller provides is to generate, assign a name for, and save a sequence of operations, called programs, to be performed on an appliance. The sequence of operations can contain idle periods between operations in which no operations are performed, or control points, which determine operations to be performed based on feedback from the appliance. For example, a program can perform a series of operations to adjust all the settings on a washer/dryer so that the appliance is in the correct state for washing a particular type of clothes, or a program might specify a series of cooking times and temperatures for baking a particular type of bread.

The appliance controller helps the user to construct programs. Each program is identified by a name. When a program is invoked, all of its operations are performed in a specified order. The program can be invoked by selecting utterances and performing actions in the appliance controller user interface 300. Additionally, some appliances are enabled with programmable buttons that can be programmed over the network 110. The appliance controller can send the program, including its name, to the appliance. The name appears as a label on one of the programmable buttons of the appliance. When the user presses this programmable button, the associated program is invoked, i.e., the sequence of operations is performed.

Scheduling Future Operation

Another important function that the appliance controller can provide for many or all appliances is to schedule future operations. In our preferred embodiment, there is a single scheduler. Users can also schedule and track personal appointments and other schedule-related information using the scheduler.

When using the scheduler, the task window 304 in FIG. 3 contains a scheduling interface similar to the interface on common scheduling software systems. The scheduling interface shows a calendar. The calendar can be displayed either one day at a time, one week at a time, or one month at a time.

Future operations of appliances are scheduled directly or indirectly. To schedule the operations directly, the user adds an entry to a schedule for a specified time on a future day that specifies an operation for an appliance, e.g., that a sprinkler system should water the lawn for one hour on Aug. 12, 2004 starting at noon. The appliance controller then initiates the specified operation on the specified day and time. However, if the appliance is able to accept a sequence of future operations over the network 110, then the appliance controller sends the schedule to the appliance.

Note that an appliance can perform operations defined for the future without having the capability for scheduling future operations on the appliance itself. Also, an important advantage is that the user can see all future operations for all appliances on a single user interface.

Future operations can also be scheduled indirectly. In this case, users specify their expected locations and behavior in the future. For example, each user can schedule when the user expects to be away, or when the user sleeps, or where the user is located. If nothing is scheduled for a given time, then the appliance controller assumes that the user is in the house and possibly in any part of the house. Then, the appliance controller can infer a state of the house in the future, such as there are no users in the house, or the users are sleeping.

The users can also generate and modify rules for the appliance controller using the appliance controller user interface 300 to specify the state appliances should be put into when the house is in different states. For example, users can specify different temperature target settings for when the house is empty, when there are people in the house, or when everyone is sleeping. Users can also specify that lights be turned on and off when nobody is home to give the impression to anyone outside the house that people are, in fact, present.

Furthermore, the users can specify operations to be performed when the house changes from one state to another, or in anticipation of such a change. For example, users can specify that the heater be turned on twenty minutes before anyone is expected to arrive home.

The appliance-specific plug-ins contain software widgets to ease the specification of operations and rules for each appliance. For example, the plug-in for a home thermostat contains a GUI widget to appear in the task window 304 that allows users to easily specify temperature ranges for each zone or room of the house for each state of the house, e.g., sleeping, empty, occupied, or only adults home.

Dynamic Control of Multiple Appliances

Our preferred embodiment of the appliance controller also allows the users to indicate dynamically the state of the house. For example, the users can indicate to the appliance controller that they want the house to enter sleeping mode, which causes the appliance controller to turn off the lights and televisions, etc. The appliance controller can also infer the state of the house from the users interaction with appliances on the network. For example, the appliance controller indicates that the house is empty when the user turns on the alarm system, and the appliance controller infers that the house should change from a sleeping state to an awake state at 7:00 am when the user sets the alarm for 7:00 am.

Feedback Information

The appliance controller has the ability to collect usage information for the appliances. To do so, the appliance indicates to the appliance controller over the network 110 all user operations performed on that appliance. The appliance controller records when each operation is performed. This information is then relayed back to the manufacturer or designer of the appliance. The manufacturer can use this information to improve future versions of the appliance or to improve the appliance APIs used on the appliance controller.

Additionally, the appliance controller software compares usage of an appliance over some extended period of time with typical usage of an appliance. Based on this comparison, the appliance controller informs the user about commonly used features that the user does not use at all, or does not use in situations in which they are commonly used.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A single common graphical user interface for a network of home appliances, comprising:
a communication window, connected to the network, further comprising:
agent utterance bubbles associated with a software agent, the agent utterance bubbles displaying agent utterances;
user utterance bubbles associated with a user of the appliances, the user utterances bubbles displaying user utterances to be selected by the user in response to the agent utterances; and
a task window, connected to the network, further comprising:
a selection window for selecting tasks and appliances; and
an application program interface for a selected one of the tasks and appliances.

2. The interface of claim 1, in which the communication window further comprises:
scroll bars; and
a task path.

3. The interface of claim 1, in which the utterances are statements in a natural language.

4. The interface of claim 1, in which the agent utterances are vocalized using a speech synthesizer.

5. The interface of claim 1, in which the user utterances are selected by speech.

6. The interface of claim 1, in which the user utterances are selected by a mechanical input device.

7. The interface of claim 1, in which the agent utterances and the user utterances form a dialog.

8. The interface of claim 1, in which the agent utterances and the user utterances scroll-up according to a progress of the dialog so that only most recent utterances are displayed.

9. The interface of claim 1, in which an order of the utterances is indicated by a display intensity of the utterances.

10. The interface of claim 1, in which a state of the communication window and the task window define a current context of the interface.

11. The interface of claim 10, in which the utterances are generated according to the context and plug-ins associated with the appliances.

12. The interface of claim 2, in which the scroll bars are used to view a history of the utterances.

13. The interface of claim 1, in which the communication window and the task window are used to define a sequence of operations for the selected appliance.

14. The interface of claim 13, in which a name is assigned to the sequence of operations.

15. The interface of claim 14, further comprising:
means for invoking the sequence of operations for the selected appliance by the name.

16. The interface of claim 1, further comprising:
a single scheduler for all appliances and all tasks, the scheduler maintaining a schedule.

17. The interface of claim 14, further comprising:
a single scheduler for all appliances and all tasks, and in which the sequence of operations is invoked according to the schedule.

18. A network of home appliances, comprising:
a plurality of home appliances;
a network connected to the plurality of home appliances;
a single appliance controller for the plurality of home appliances, the single appliance controller further comprising:
a communication window, connected to the network, for displaying agent utterances and user utterance forming a dialog; and
a task window, connected to the network, for selecting user tasks and appliance operations.
